(19) United States
(12) Patent Application Publication
(10) Pub. No.: US 2018/0059699 A1
(43) Pub. Date: Mar. 1, 2018

(54) LINEAR REGULATOR

(71) Applicant: SHENZHEN GOODIX TECHNOLOGY CO., LTD., Shenzhen (CN)

(72) Inventor: Chengzuo Wang, Shenzhen (CN)

(73) Assignee: SHENZHEN GOODIX TECHNOLOGY CO., LTD., Shenzhen (CN)

(21) Appl. No.: 15/790,976

(22) Filed: Oct. 23, 2017

Related U.S. Application Data
(63) Continuation of application No. PCT/CN2016/095428, filed on Aug. 16, 2016.

(51) Int. Cl. G05F 1/575

(52) U.S. Cl. CPC G05F 1/575

(57) ABSTRACT

A linear regulator includes: a current bias module, a voltage bias module having positive temperature characteristics, and a flip voltage follower. An input end of the current bias module receives an input voltage of the linear regulator, and an output end of the current bias module outputs a bias current. A first input end and a second input end of the voltage bias module receive the input voltage and the bias current, respectively, and an output end of the voltage bias module outputs a bias voltage. A first input end and a second input end of the flip voltage follower receive the input voltage and the bias voltage, respectively, and an output end of the flip voltage follower outputs an output voltage of the linear regulator.

### CROSS-REFERENCE TO RELATED APPLICATION

The present application is a continuation of international application No. PCT/CN2016/095428 filed on Aug. 16, 2016, which is hereby incorporated by reference herein, in its entirety.

### TECHNICAL FIELD

The present disclosure relates to the field of electronics, and in particular, to a linear regulator.

### BACKGROUND

A linear regulator is also referred to as a series regulator. A linear regulator can be used to convert an unstable input voltage into an adjustable direct output voltage so as to provide a power source to another system. A linear regulator has a simple structure, less static power consumption, and a small output voltage ripple etc. As a result, the linear regulator is generally used for the intra-chip power source management of a chip in a consumer mobile electronic device.

FIG. 1 is a schematic structural diagram of a linear regulator in the related art. The linear regulator includes: a bias module 1, a reference voltage module 2, an error amplifier 3, a power transistor 4, and a sampling resistor network 5.

An input voltage V_{IN} of the linear regulator is input into the bias module 1, the reference voltage module 2, and the power transistor 4, respectively. The bias module 1 provides a current bias and a voltage bias to the reference voltage module 2 and the error amplifier 3 for a normal operation of the reference voltage module 2 and the error amplifier 3. The reference voltage module 2 generates a reference voltage V_{REF} with a low temperature drift for the error amplifier 3. The error amplifier 3 amplifies an error between V_{REF} and a feedback voltage V_{FB} that is obtained by sampling an output voltage V_{O} by a sampling resistor network 5, so as to regulate a gate voltage of the power transistor 4 according to an error amplification result and to stabilize an output of the output voltage V_{O}.

With fast development of technologies in the Internet of Things, people have higher requirements on mobile consumer electronic devices. When a system of an electronic device is in a sleeping standby state, power consumption of intra-chip power source management of an electronic device chip should be as low as possible, so as to achieve a longer device operation time and a relatively long electronic device standby time. However, a linear regulator in the related art may be difficult to satisfy a requirement that a static current is in the range of hundreds of nanoamperes or even dozens of nanoamperes when the electronic device is in a standby state. In addition, the sampling resistor network 5 in the linear regulator of related art occupies a relatively large chip area, which is disadvantageous to the development of miniaturizing an electronic device.

### SUMMARY

One of the objectives of the embodiments of the present disclosure is to provide a linear regulator with relatively low static power consumption and a relatively small area on a chip. Also, due to the fact that a voltage bias module with positive temperature characteristics compensates negative temperature characteristics of a flip voltage follower, an output voltage of the linear regulator can have good temperature characteristics even when the linear regulator does not have a reference voltage module.

To solve the above technical problem, an embodiment the present disclosure provides a linear regulator including a current bias module, a voltage bias module having positive temperature characteristics, and a flip voltage follower.

An input end of the current bias module receives an input voltage of the linear regulator, and an output end of the current bias module outputs a bias current.

A first input end and a second input end of the voltage bias module receive the input voltage and the bias current respectively, and an output end of the voltage bias module outputs a bias voltage.

A first input end and a second input end of the flip voltage follower receive the input voltage and the bias voltage respectively, and an output end of the flip voltage follower outputs an output voltage of the linear regulator.

In the embodiment of the present disclosure, as compared with the existing technologies, the input voltage of the linear regulator is input to the input end of the current bias module. In the first input end of the voltage bias module and the first input end of the flip voltage follower, the current bias module generates the bias current, and the second input end of the voltage bias module receives the bias current. The voltage bias module generates the bias voltage, and the second input end of the flip voltage follower receives the bias voltage. The output voltage of the linear regulator is output by the output end of the flip voltage follower. The flip voltage follower is provided to follow and compensate the output voltage of the linear regulator, so that the output voltage of the linear regulator is relatively stable. In addition, the voltage bias module has the positive temperature characteristics and can mutually compensate with the flip voltage follower, to offset negative temperature characteristics of the flip voltage follower, so that the output voltage of the linear regulator has good temperature characteristics. In this way, the linear regulator has characteristics of relatively low static power consumption and a relatively small chip occupation area. Also, the output voltage of the linear regulator can achieve good temperature characteristics without a need of specifically setting a reference voltage module.

In addition, the current bias module includes a bias current generation circuit and an auxiliary output circuit. An input end of the bias current generation circuit is connected to the input voltage of the linear regulator. An output end of the bias current generation circuit is connected to an input end of the auxiliary output circuit. An output end of the auxiliary output circuit is connected to the second input end of the voltage bias module. The input end of the bias current generation circuit and the output end of the auxiliary output circuit respectively form the input end and the output end of the current bias module. A required bias current (generally, the required bias current is a nanoampere-level bias current) is generated by using the bias current generation circuit, and the bias current of the bias current generation circuit is output to the voltage bias module by using the auxiliary output circuit.

In addition, the auxiliary output circuit includes a current mirror circuit and a field effect transistor, where an input end of the current mirror circuit is connected to the output end of the bias current generation circuit, and an output end of the current mirror circuit is connected to a drain of the field effect transistor; and a source and a gate of the field effect transistor are connected to the input end and the output end of the current bias module respectively. This embodiment provides a specific example of the auxiliary output circuit, that is, the bias current in the bias current generation circuit is copied to the drain of the field effect transistor by using the current mirror circuit, so that the field effect transistor inputs the bias current to the voltage bias module. In addition, by using the auxiliary output circuit including the current mirror circuit, there is a relatively large flexibility in the circuit design of such a bias current generation circuit.

In addition, the auxiliary output circuit includes a field effect transistor, where a drain and a gate of the field effect transistor form the input end and the output end of the auxiliary output circuit respectively. This embodiment provides a specific example of the auxiliary output circuit in respect of feasibility of the present disclosure.

In addition, the voltage bias module includes a series self-cascode MOSFET (SSCM) circuit, which provides a specific implementation manner of the voltage bias module, thereby increasing feasibility of the present disclosure. In addition, in the present disclosure, as the SSCM circuit can work in a sub-threshold region, static power consumption of the linear regulator can be very small.

In addition, the flip voltage follower includes a folded cascode amplifier and a power transistor; a first input end of the folded cascode amplifier and an emitter of the power transistor form the first input end of the flip voltage follower; a second input end of the folded cascode amplifier forms the second input end of the flip voltage follower; a first output end of the folded cascode amplifier is connected to a gate of the power transistor; and a second output end of the folded cascode amplifier forms the output end of the flip voltage follower and is connected to a drain of the power transistor. As the folded cascode amplifier samples an output voltage of the linear regulator and amplifies an error of the output voltage, and a result of the error method is output to the gate of the power transistor, a gate voltage of the power transistor can be regulated to stabilize the output voltage of the linear regulator.

In addition, the flip voltage follower further includes an output capacitor. The output capacitor is placed between an output end and a ground end of the flip voltage follower. The output capacitor is used to stabilize the linear regulator.

### BRIEF DESCRIPTION OF THE DRAWINGS

FIG. 1 is a schematic structural diagram of a linear regulator in the related art;

FIG. 2 is a schematic structural diagram of a linear regulator according to a first embodiment of the present disclosure;

FIG. 3 is a schematic circuit diagram of a linear regulator according to the first embodiment of the present disclosure;

FIG. 4 is a schematic circuit diagram of a nanoampere-level bias current generation circuit according to the first embodiment of the present disclosure; and

FIG. 5 is a schematic circuit diagram of a linear regulator according to a second embodiment of the present disclosure.

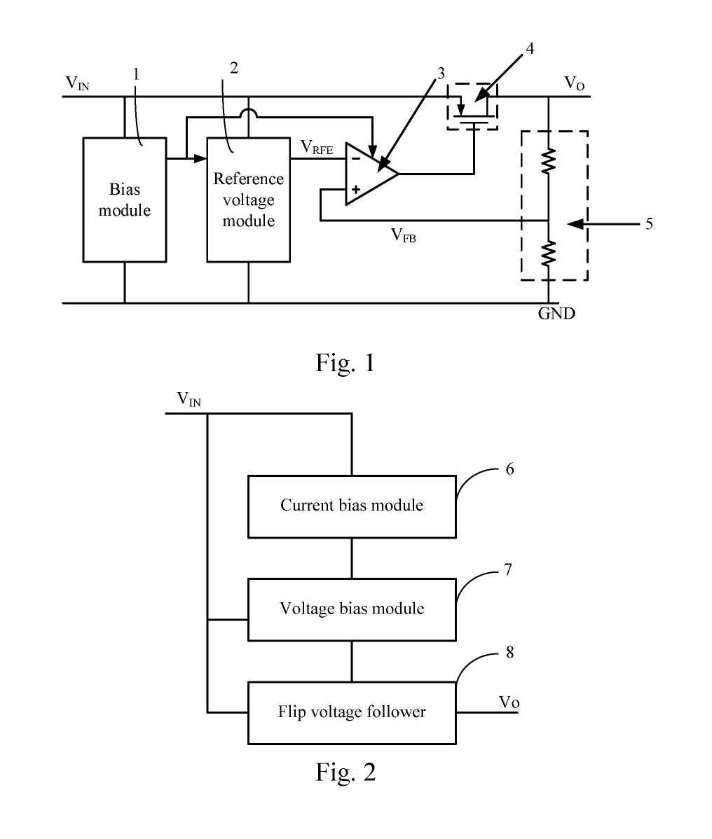

### DETAILED DESCRIPTION

To make the objectives, technical solutions, and advantages of the present disclosure clearer, the following describes the details of various embodiments of the present disclosure with reference to the accompanying drawings. However, a person skilled in the art can understand that in the embodiments of the present disclosure, many technical details are provided to make the readers to better understand this application. However, even if such technical details and various changes and modifications that are based on the following embodiments are not provided, the technical solutions of this application can also be achieved.

A first embodiment of the present disclosure relates to a linear regulator. As shown in FIG. 2, the linear regulator includes a current bias module, a voltage bias module having positive temperature characteristics, and a flip voltage follower. The linear regulator in this embodiment may be applied to mobile terminals having rechargeable cells, such as a mobile phone, a computer, a tablet computer, and a wearable device.

An input end of the current bias module 6 receives an input voltage V_{IN} of the linear regulator, and an output end of the current bias module 6 outputs a bias current. A first input end and a second input end of the voltage bias module 7 respectively receives the input voltage V_{IN} and the bias current, and an output end of the voltage bias module 7 outputs a bias voltage. A first input end and a second input end of the flip voltage follower 8 respectively receives the input voltage V_{IN} and the bias voltage, and an output end of the flip voltage follower 8 outputs an output voltage V_{O} of the linear regulator.

Specifically, the current bias module 6 generates the bias current and outputs the bias current to the voltage bias module 7, and the voltage bias module 7 generates the bias voltage. The flip voltage follower 8 is configured to follow and compensate the output voltage V_{O} of the linear regulator, so that the output voltage V_{O} of the linear regulator is relatively stable. In addition, the voltage bias module 7 has the positive temperature characteristics and can mutually compensate with the flip voltage follower 8, thus to offset negative temperature characteristics of the flip voltage follower 8, so that the output voltage V_{O} of the linear regulator may have good temperature characteristics.

In this embodiment, the current bias module 6 includes a bias current generation circuit and an auxiliary output circuit. An input end of the bias current generation circuit is connected to the input voltage V_{IN} of the linear regulator; and an output end of the bias current generation circuit is connected to an input end of the auxiliary output circuit. An output end of the auxiliary output circuit is connected to the input end of the voltage bias module 7. The input end of the bias current generation circuit and the output end of the auxiliary output circuit respectively form the input end and the output end of the current bias module. A required bias current (generally, the required bias current is a nanoampere-level bias current) can be generated by using the bias current generation circuit, and the bias current of the bias current generation circuit is output to the voltage bias module by using the auxiliary output circuit.

The auxiliary output circuit includes a current mirror circuit and a field effect transistor. An input end of the current mirror circuit is connected to the output end of the bias current generation circuit, and an output end of the current mirror circuit is connected to a drain of the field effect transistor. A source and a gate of the field effect transistor are respectively connected to the input end and the output end of the current bias module. The bias current in the bias current generation circuit is copied to the drain of the field effect transistor by using the current mirror circuit, so that the field effect transistor inputs the bias current to the voltage bias module. In addition, by using the auxiliary output circuit with the current mirror circuit, there is a relative flexibility in selecting a model of the bias current generation circuit.

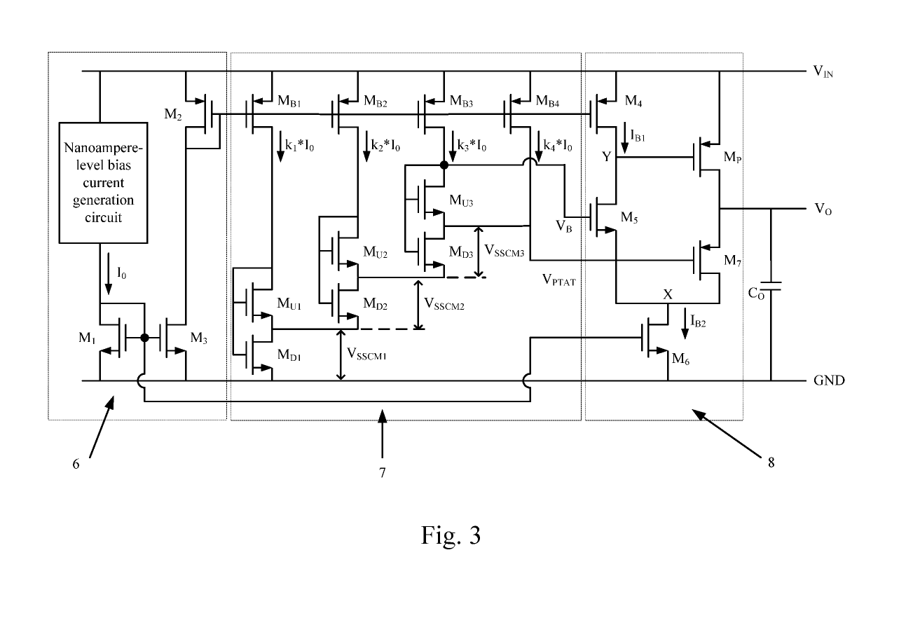

A working principle of the linear regulator may be described below by reference to a circuit shown in FIG. 3.

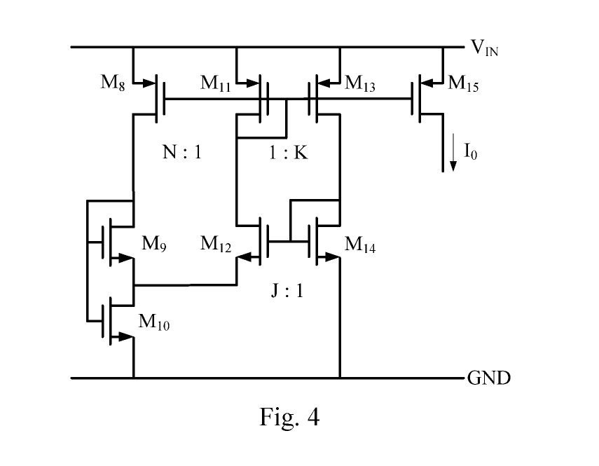

The current bias module 6 includes a bias current generation circuit and an auxiliary output circuit. The bias current generation circuit may be a nanoampere-level bias current generation circuit shown in FIG. 3. The auxiliary output circuit includes a current mirror circuit and a field effect transistor M₂. The current mirror circuit may include field effect transistors M₁ and M₃, a drain of the field effect transistor M₁ is used as the input end of the current mirror circuit, and a drain of the field effect transistor M₃ is used as the output end of the current mirror circuit. FIG. 4 refers to an embodiment of a specific circuit of the nanoampere-level bias current generation circuit. As shown in FIG. 4, sources of field effect transistors M₈, M₁₁, M₁₃, and M₁₅ are used as input ends of the nanoampere-level bias current generation circuit, a drain of the field effect transistor M₁₅ is used as an output end of the nanoampere-level bias current generation circuit.

N, J, and K in FIG. 4 represent mirror ratios of current mirror circuits. N is a mirror ratio of a current mirror circuit including transistors M₁₁ and M₈. J is a mirror ratio of a current mirror circuit including transistors M₁₄ and M₁₂. K is a mirror ratio of a current mirror circuit including transistors M₁₁ and M₁₃. M₉ and M₁₀ construct a self-cascode transistor (SCM) circuit.

Transistors M₈ to M₁₄ are main circuits of the nanoampere-level bias current generation circuit, and M₁₅ is a bias current output end of the nanoampere-level bias current generation circuit.

Because the current mirror circuit including the M₁₄ and M₁₂ works in the sub-threshold region, and the mirror ratio is greater than 1 (J>1), thus gate-source voltages V_{GS} of M₁₂ and M₁₄ are different, and V_{GS14}>V_{GS12}. A source of M₁₂ generates a voltage, and the voltage is a difference between V_{GS14} and V_{GS12}.

For the SCM circuit with M₉ and M₁₀, M₁₀ works in a linear region, and may be equivalent to a resistor in electrical characteristics. In addition, because the drain of M₁₀ is biased by a source voltage of M₁₂, a generated output current is equal to a ratio of the source voltage of M₁₂ to an equivalent resistor of M₁₀.

Because a difference between V_{GS14} and V_{GS12} is relatively small and is only dozens of millivolts, and the equivalent resistor of M₁₀ is a transistor resistor, in an actual operation, M₁₀ may be designed into an inverted transistor and a very large equivalent resistance can be obtained accordingly, so as to obtain output of the nanoampere-level bias current.

In conclusion, the nanoampere-level bias current generation circuit mentioned in this embodiment has features of a small output bias current, low static power consumption, and a small chip occupation area.

The input end of the nanoampere-level bias current generation circuit or the source of the field effect transistor M₂ is used as the input end of the current bias module 6 and receive the input voltage V_{IN} of the linear regulator. The gate of the field effect transistor M₂ is used as the output end of the current bias module 6 and is connected to the input end of the voltage bias module 7. The output end of the nanoampere-level bias current generation circuit is connected to the drain of the field effect transistor M₁. The gate of the field effect transistor M₁ is connected to the drain of the transistor M₁, and is also connected to the gate of the field effect transistor M₃. The drain of the field effect transistor M₃ is connected to the drain of the field effect transistor M₂. The source of the field effect transistor M₁ and the source of the field effect transistor M₃ are both grounded.

The voltage bias module 7 with positive temperature characteristics can be a series self-cascode MOSFET (SSCM) circuit, and a number of stages of the SSCM circuit can be three. The SSCM circuit may include field effect transistors M_{B1} to M_{B4}, M_{U1} to M_{U3}, and M_{D1} to M_{D3} shown in FIG. 3. In this embodiment, the number of stages of the SSCM circuit is not limited, and may be selected according to various requirements for an amount of compensation and for the output voltages V_{O}. In addition, it should be noted that a specific structural form of the voltage bias module is not limited in this embodiment. Any structural form of the voltage bias module having the positive temperature characteristics can be applied to this embodiment.

Specifically, the field effect transistors M_{B1}, M_{U1}, and M_{D1} shown in FIG. 3 may form a first stage circuit of the SSCM circuit, M_{B2}, M_{U2}, and M_{D2} may form a second stage circuit of the SSCM circuit, and M_{B3}, M_{U3}, and M_{D3} may form a third stage circuit of the SSCM circuit. Circuits of various stages in the SSCM circuit are described in details below.

A first stage circuit of the SSCM circuit:

A source of a transistor M_{B1} receives the input voltage V_{IN} of the linear regulator, a gate of the transistor M_{B1} is connected to the gate of the field effect transistor M₂, and a drain of the transistor M_{B1} is connected to a drain of a transistor M_{U1}. A gate and the drain of the transistor M_{U1} are connected to each other, and a source of the transistor M_{U1} is connected to a drain of the transistor M_{D1}. A gate of the transistor M_{D1} is connected to the gate of the transistor M_{U1}, and a source of the transistor M_{U1} is grounded. The drain of the transistor M_{D1} is connected to the source of the transistor M_{U1} and is used as an output end of the first stage of the SSCM circuit, and an output voltage is V_{SSCM1}.

Accordingly, V_{SSCM1}=V_{GS}_{_}_{MD1}−V_{GS}_{_}_{MU1}, V_{GS}_{_}_{MD1} is a gate-source voltage of the transistor M_{D1}, and V_{GS}_{_}_{MU1} is a gate-source voltage of the transistor M_{U1}. A current amplification coefficient of M_{B1} is k₁, so that a bias current I₀ generated by the nanoampere-level bias current generation circuit can be amplified to k₁*I₀ after passing through the transistor M_{B1}.

A second stage circuit of the SSCM circuit:

A source of a transistor M_{B2} receives the input voltage V_{IN} of the linear regulator, a gate of the transistor M_{B2} is connected to the gate of the field effect transistor M₂, and a drain of the transistor M_{U2} is connected to a drain of the transistor M_{U2}. A gate and the drain of the transistor M_{U2} are connected to each other, and a source of the transistor M_{U2} is connected to a drain of the transistor M_{D2}. A gate of the transistor M_{D2} is connected to the gate of the transistor M_{U2}, and a source of the transistor is grounded. The drain of the transistor M_{D2} is connected to the source of the transistor M_{U2} and is used as an output end of the second stage of the SSCM circuit, and an output voltage is V_{SSCM2}.

Accordingly, V_{SSCM2}=V_{GS}_{_}_{MD2}−V_{GS}_{_}_{MU2}, V_{GS}_{_}_{MD2} is a gate-source voltage of the transistor M_{D2}, and V_{GS}_{_}_{MU2} is a gate-source voltage of the transistor M_{U2}. A current amplification coefficient of the transistor M_{U2} is k₂, so that a bias current I₀ generated by the nanoampere-level bias current generation circuit may be amplified to k₂*I₀ after passing through the transistor M_{B2}.

A third stage circuit of the SSCM circuit:

A source of a transistor M_{B3} receives the input voltage V_{IN} of the linear regulator, a gate of the transistor M_{B3} is connected to the gate of the field effect transistor M₂, and a drain of the transistor M_{B3} is connected to a drain of the transistor M_{U3}. A gate and the drain of the transistor M_{U3} are connected to each other, and a source of the transistor M_{U3} is connected to a drain of the transistor M_{D3}. A gate of the transistor M_{D3} is connected to the gate of the transistor M_{U3}, and a source of the transistor is grounded. The drain of the transistor M_{D3} is connected to the source of the transistor M_{U3} and is used as an output end of the third stage of the SSCM circuit, and an output voltage is V_{SSCM3}.

Accordingly, V_{SSCM3}=V_{GS}_{_}_{MD3}−V_{GS}_{_}_{MU3}, V_{GS}_{_}_{MD3} is a gate-source voltage of the transistor M_{D3}, and V_{GS}_{_}_{MU3} is a gate-source voltage of the transistor M_{U3}. A current amplification coefficient of M_{B3} is k₃, so that a bias current I₀ generated by the nanoampere-level bias current generation circuit may be amplified to k₃*I₀ after passing through the transistor M_{B3}.

The flip voltage follower 8 may include a folded cascode amplifier and a power transistor M_{P}. The folded cascode amplifier may include field effect transistors M₄ to M₇. A source of the field effect transistor M₄ is a first input end of the folded cascode amplifier and forms the first input end of the flip voltage follower 8 together with an emitter of the power transistor M_{P}. A gate of the field effect transistor M₅ is a second input end of the folded cascode amplifier and forms the second input end of the flip voltage follower 8. A drain of the field effect transistor M₄ is a first output end of the folded cascode amplifier and is connected to a gate of the power transistor M_{P}. A source of the field effect transistor M₇ is a second input end of the folded cascode amplifier, forms the output end of the flip voltage follower 8, and is connected to a drain of the power transistor M_{P}.

Specifically, the nanoampere-level bias current generation circuit generates the bias current I₀. I₀ is output to the SSCM circuit after being converted by the current mirror circuit. The SSCM circuit output voltages V_{B} and V_{PTAT} respectively acting on the gate of the field effect transistor M₅ and the gate of the field effect transistor M₇. When the input voltage V_{IN} of the linear regulator powers up and a circuit stably works, the output voltage of the linear regulator is V_{O}=V_{PTAT}+V_{GS7}. V_{GS7}=V_{TH}+V_{OVM7}, V_{TH} is a threshold voltage of the field effect transistor M₇, V_{oVM7} is an overdrive voltage of the field effect transistor M₇, and when the field effect transistor M₇ works in a sub-threshold region, V_{oVM7} may be omitted.

The source of the field effect transistor M₇ samples the output voltage V_{O} of the linear regulator, then the folded cascode amplifier including the field effect transistors M₄ to M₇ performs an error amplification, and a result of the error amplification is output at a node Y and acts on the gate of the power transistor M_{P}. The field effect transistor M₄ and the field effect transistor M₆ provide bias currents I_{B1} and I_{B2} to the folded cascode amplifier respectively, and I_{B2}>I_{B1}. V_{B} is biased at the gate of the field effect transistor M₅ so that a node X has a proper bias voltage, to ensure that the field effect transistor M₆ and the field effect transistor M₇ both work at a proper working voltage.

Because the input voltage V_{IN} of the linear regulator remains the same, if the output voltage V_{O} of the linear regulator increases, a voltage V_{O}-V_{IN} on the folded cascode amplifier also increases. In this way, a voltage on the Y node increases, so that the power transistor M_{P} is closed, and the output voltage V_{O} of the linear regulator decreases. Otherwise, if the output voltage V_{O} of the linear regulator decreases, the voltage V_{O}-V_{IN} on the folded cascode amplifier decreases, and the voltage on the Y node also decreases. In this case, the power transistor M_{P} increases a supply current, so that the output voltage V_{O} of the linear regulator increases.

It should be noted that in this embodiment, the flip voltage follower 8 may further include an output capacitor C₀. The output capacitor C₀ is connected between the output end and a ground end of the flip voltage follower 8. Stability of the linear regulator may be enhanced by using the output capacitor C₀.

A principle of mutual compensation of the voltage bias module 7 and the flip voltage follower 8 can be described below.

It can be known from the above descriptions that V_{O}=V_{PTAT}+V_{GS7}. Because the flip voltage follower 8 has negative temperature characteristics, the SSCM circuit needs to be reasonably designed, so that the SSCM circuit has proper positive temperature characteristics, such that the output voltage V_{O} of the linear regulator has good accuracy within a full temperature range. That is, V_{PTAT} in the SSCM circuit needs to be made to have proper positive temperature characteristics, so that V_{PTAT} can compensate negative temperature characteristics of the flip voltage follower 8.

In this embodiment, a number of stages of the SSCM circuit is three, and output of an ith stage of the SSCM circuit is V_{SSCMI}=V_{GS}_{_}_{MDi}−V_{GS}_{_}_{MUi}. Because the SSCM circuit works in the sub-threshold region, an output of each stage of the SSCM circuit is obtained according to a current-voltage formula of the sub-threshold region:

$$\begin{matrix}{V}_{SSCMi} = {nV}_{T} ln \frac{{\sum }_{j = i}^{4} {k}_{j} {I}_{0}}{{I}_{S 0} {S}_{MDi}} - {nV}_{T} ln \frac{{k}_{i} {I}_{0}}{{I}_{S 0} {S}_{MUi}} \\ = {nV}_{T} ln \frac{{\sum }_{j = i}^{4} {k}_{j} \times {S}_{MUi}}{{k}_{i} \times {S}_{MDi}} , i = 1 , 2 , 3\end{matrix} \qquad Formula ( 1 )$$

where n is a sub-threshold slope coefficient, V_{T} is a thermal voltage, I_{S0} is a process-related parameter, and S_{MDi} and S_{MUi} respectively represent channel width-length ratios of the transistor M_{Di} and the transistor M_{Ui}.

When formula (1) is incorporated with FIG. 3, a formula (2) can be obtained as:

$$\begin{matrix}{V}_{PTAT} = {V}_{SSCM 1} + {V}_{SSCM 2} + {V}_{SSCM 3} \\ = {nV}_{T} ln \frac{( {\sum }_{j = 1}^{4} {k}_{j} ) \times {S}_{MU 1}}{{k}_{1} \times {S}_{MD 1}} + {nV}_{T} ln \frac{( {\sum }_{j = 2}^{4} {k}_{j} ) \times {S}_{MU 2}}{{k}_{2} \times {S}_{MD 2}} + \\ {nV}_{T} ln \frac{( {\sum }_{j = 3}^{4} {k}_{j} ) \times {S}_{MU 3}}{{k}_{3} \times {S}_{MD 3}} \\ = {nV}_{T} ln \frac{{\prod }_{x = 1}^{3} [ ( {\sum }_{j = x}^{4} {k}_{j} ) \times {S}_{MUx} ]}{{\prod }_{x = 1}^{3} ( {k}_{x} \times {S}_{MDx} )}\end{matrix}$$

A known threshold voltage of the field effect transistor may be represented as the following formula (3):

V_{TH}(T)|=|V_{TH}(T₀)|−α_{VT}(T−T₀) Formula (3)

T is an absolute temperature, T₀ is a reference absolute temperature (such as a room temperature), and α_{VT} is a temperature coefficient of the threshold voltage of the field effect transistor.

Assuming that the field effect transistor M₇ also works in the sub-threshold region, the output voltage V_{O} may be obtained as the following formula (4) by combining formula (2) and formula (3):

$${V}_{O} = {nV}_{T} ln \frac{{\prod }_{x = 1}^{3} [ ( {\sum }_{j = x}^{4} {k}_{j} ) \times {S}_{MUx} ]}{{\prod }_{x = 1}^{3} ( {k}_{x} \times {S}_{MDx} )} + [ \vert {V}_{TH} ( {T}_{0} ) \vert - {α}_{VT} ( T - {T}_{0} ) ] + {nV}_{T} ln \frac{{I}_{B 2} - {I}_{B 1}}{{I}_{S 0} {S}_{M 7}} \qquad formula ( 4 )$$

It can be seen that when the quantity of stages of the SSCM circuit is N, formula (4) can be expanded as:

$${V}_{O} = {nV}_{T} ln \frac{{\prod }_{x = 1}^{N} [ ( {\sum }_{j = x}^{N + 1} {k}_{j} ) \times {S}_{MUx} ]}{{\prod }_{x = 1}^{N} ( {k}_{x} \times {S}_{MDx} )} + [ \vert {V}_{TH} ( {T}_{0} ) \vert - {α}_{VT} ( T - {T}_{0} ) ] + {nV}_{T} ln \frac{{I}_{B 2} - {I}_{B 1}}{{I}_{S 0} {S}_{M 7}} , \\ N = 1 , 2 … \qquad formula ( 5 )$$

When the output voltage V_{O} is derived with respect to the temperature, the following can be obtained:

$$\begin{matrix}\frac{\partial {V}_{O}}{\partial T} = n \frac{{k}_{b}}{q} ln \frac{{\prod }_{x = 1}^{3} [ ( {\sum }_{j = x}^{4} {k}_{j} ) \times {S}_{MUx} ] \times ( {I}_{B 2} - {I}_{B 1} )}{{\prod }_{x = 1}^{3} ( {k}_{x} \times {S}_{MDx} ) \times ( {I}_{S 0} {S}_{M 7} )} - {α}_{VT} \\ And & formula ( 6 ) \\ \frac{\partial {V}_{O}}{\partial T} = n \frac{{k}_{b}}{q} ln \frac{{\prod }_{x = 1}^{N} [ ( {\sum }_{j = x}^{N + 1} {k}_{j} ) \times {S}_{MUx} ] \times ( {I}_{B 2} - {I}_{B 1} )}{{\prod }_{x = 1}^{N} ( {k}_{x} \times {S}_{MDx} ) \times ( {I}_{S 0} {S}_{M 7} )} - {α}_{VT} , \\ N = 1 , 2 … & formula ( 7 )\end{matrix}$$

where k_{b} is a Boltzmann constant, and q is a potential-charge constant.

It can be known from formula (6) and formula (7) that when the quantity of stages of SSCM, a current amplification coefficient kᵢ (i=1, 2, . . . , N, N+1), sizes of M_{Ui} and M_{Di}(i=1, 2, . . . , N), and a size of the field effect transistor M₇ are properly designed so that

$$\frac{\partial {V}_{O}}{\partial T} = 0$$

can be achieved, thus the output voltage V_{O} can have a zero temperature characteristic.

It can be seen that in this embodiment, the flip voltage follower 8 is provided to follow and compensate the output voltage of the linear regulator, so that the output voltage of the linear regulator is relatively stable. In addition, the voltage bias module 7 has the positive temperature characteristics and can mutually compensate with the flip voltage follower 8, to offset negative temperature characteristics of the flip voltage follower 8, so that the output voltage of the linear regulator has good temperature characteristics. In this way, the linear regulator does not require specifically setting a reference voltage module, which saves current consumption and which results a linear regulator with characteristics of relatively low static power consumption and a relatively small area on a chip.

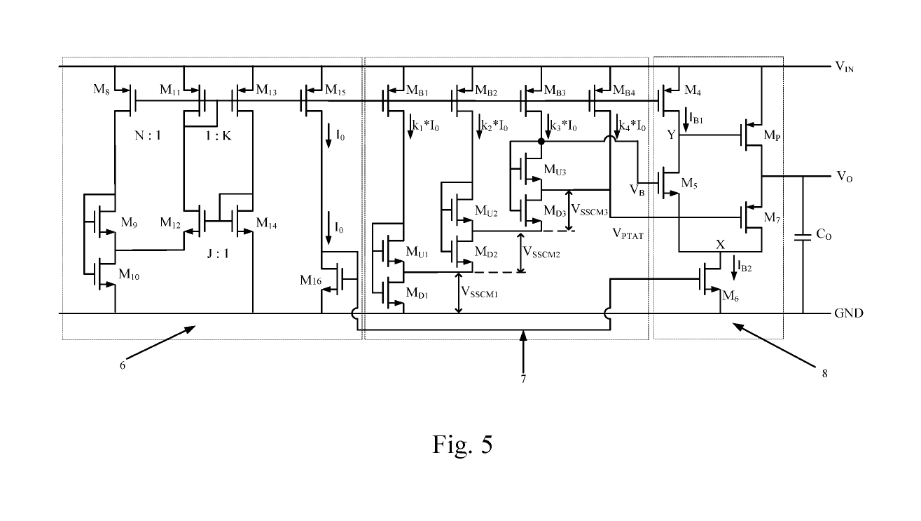

A second embodiment of the present disclosure relates to a linear regulator, as shown in FIG. 5. The second embodiment and the first embodiment are substantially the same and mainly differ in that: in the first embodiment of the present disclosure, the auxiliary output circuit includes a current mirror circuit and a field effect transistor. In the second embodiment of the present disclosure, the auxiliary output circuit includes only a field effect transistor M₁₆.

Specifically, a drain and a gate of the field effect transistor M₁₆ respectively form the input end and the output end of the auxiliary output circuit. The drain of the field effect transistor M₁₆ is connected to the input end of the nanoampere-level bias current generation circuit, and the gate is connected to the gate of the field effect transistor M₆ of the folded cascode amplifier. A source of M₁₆ is grounded, and a gate is further connected to the drain of M₁₆.

In this embodiment, there is no need to connect the field effect transistor M₁₆ to the SSCM circuit, and a function of the field effect transistor M₁₆ is to receive a bias current and provide the bias current to the flip voltage follower 8.

A person of ordinary skill in the art can understand that the above embodiments are specific examples of the present disclosure. However, in an actual application, various changes or modification can be made to the forms and details of these specific examples without departing from the spirit and the scope of the present disclosure.

What is claimed is:

1. A linear regulator, comprising:
a current bias module, comprising an input end and an output end, wherein the input end of the current bias module is configured to receive an input voltage of the linear regulator, and the output end of the current bias module is configured to output a bias current;
a voltage bias module having positive temperature characteristics, comprising a first input end, a second input end and an output end, wherein the first input end of the voltage bias module is configured to receive the input voltage, the second input end of the voltage bias module is configured to receive the bias current, and the output end of the voltage bias module is configured to output a bias voltage; and
a flip voltage follower, comprising a first input end, a second input, and an output end, wherein the first input end of the flip voltage follower is configured to receive the input voltage, the second input end of the flip voltage follower is configured to receive the bias voltage, and the output end of the flip voltage follower is configured to output an output voltage of the linear regulator.

2. The linear regulator according to claim 1, wherein the current bias module comprises a bias current generation circuit and an auxiliary output circuit;
wherein an input end of the bias current generation circuit is connected to the input voltage of the linear regulator;
wherein an output end of the bias current generation circuit is connected to an input end of the auxiliary output circuit;
wherein an output end of the auxiliary output circuit is connected to the second input end of the voltage bias module; and
wherein the input end of the bias current generation circuit and the output end of the auxiliary output circuit are configured as the input end of the current bias module and the output end of the current bias module respectively.

3. The linear regulator according to claim 2, wherein: the auxiliary output circuit comprises a current mirror circuit and a field effect transistor;
an input end of the current mirror circuit is connected to the output end of the bias current generation circuit, and an output end of the current mirror circuit is connected to a drain of the field effect transistor; and
a source and a gate of the field effect transistor are connected to the input end of the current bias module and the output end of the current bias module respectively.

4. The linear regulator according to claim 2, wherein: the auxiliary output circuit comprises a field effect transistor; and
a drain and a gate of the field effect transistor are configured as the input end of the auxiliary output circuit and the output end of the auxiliary output circuit respectively.

5. The linear regulator according to claim 2, wherein the bias current generation circuit comprises a nanoampere-level bias current generation circuit.

6. The linear regulator according to claim 1, wherein the voltage bias module comprises a series self-cascode MOSFET (SSCM) circuit.

7. The linear regulator according to claim 6, wherein a number of stages of the SSCM circuit is three.

8. The linear regulator according to claim 1, wherein the flip voltage follower comprises a folded cascode amplifier and a power transistor;
wherein a first input end of the folded cascode amplifier and an emitter of the power transistor are configured as the first input end of the flip voltage follower;
wherein a second input end of the folded cascode amplifier is configured as the second input end of the flip voltage follower;
wherein a first output end of the folded cascode amplifier is connected to a gate of the power transistor; and
wherein a second output end of the folded cascode amplifier is configured as the output end of the flip voltage follower and is connected to a drain of the power transistor.

9. The linear regulator according to claim 8, wherein the power transistor comprises a field effect transistor.

10. The linear regulator according to claim 8, wherein the flip voltage follower further comprises an output capacitor; and
wherein the output capacitor is connected between the output end and a ground end of the flip voltage follower.
